(19) United States
(12) Patent Application Publication
(10) Pub. No.: US 2002/0009098 A1
(43) Pub. Date: Jan. 24, 2002

(54) Communication control method and device

(75) Inventor: Dieter E. Staiger, Weil im Schoenbuch (DE)

Correspondence Address: William A. Kinnaman, Jr., IBM Corporation - MS P386, 2455 South Road, Poughkeepsie, NY, 12601, US

(73) Assignee: International Business Machines Corporation, Armonk, NY (US)

(21) Appl. No.: 09/904,423

(22) Filed: Jul. 12, 2001

(30) Foreign Application Priority Data
Jul. 14, 2000 (EP) 00115299.0

(51) Int. Cl. H04J 3/22; H04L 12/40

(52) U.S. Cl. 370/445; 370/465; 370/536

(57) ABSTRACT

A method and device for communication control. It is an object to provide an improved method and device which can be used with a range of standard communication facilities. A method and device are provided for controlling communication through a data network or bus. The data network or bus includes a data source and a transmission facility subdivided into a plurality of different channels. A subset of the plurality of channels is determined which the data source is allowed to seize. A data stream originating from the data source is transformed into a format permitting concurrent transmission over the subset of channels. Finally, the transformed data is transmitted concurrently over the subset of channels. The principles taught provide a method and device which allow one to utilize the provided bandwidth of a bus or network very efficiently leading to a higher statistical availability of data transport capacity.

### BACKGROUND OF THE INVENTION

1. Field of the Invention

The present invention relates in general to an improved method and device for communication control in a data network or data bus and, in particular, to an improved network or bus system for transmitting signals.

2. Description of the Related Art

A network is known as a communication system that consists of a series of points or nodes interconnected by transmission facilities. In this sense a network is comparable to a bus system that is an interconnection system among multiple participants as well. Whereby in a bus system, the transmission facilities are typically connected to all participants and utilized commonly by all of them. The transmission facilities might comprise a plurality of communication channels in order to enable concurrent or quasi concurrent communication over the plurality of channels. For example, this concept is applied in multiplexing systems, in which several signals are combined for transmission on some shared medium.

In such network or bus systems, it is desirable to transport data over the system as quickly as possible. However, the data transmission is restricted by the bandwidth, i.e. the amount of data that can be sent through a given communications facility per second. That is the maximum amount of data physically possible to transmit. Except that, in reality the average amount of data that is actually sent through the communication facility is by far lower.

A major reason for that reduced capability to transmit data in real live situations is mainly caused by the uneven use of the transmission facilities. In certain time intervals the communication facility is not used at all and in other time intervals data needs to be buffered while waiting for free transmission facilities.

Another cause lies in the fact that large data transfer may require a large bandwidth on the network or bus system while other processes may only need a small amount of data to be sent over the network system.

In order to minimize the difference between the bandwidth of a given communication facility and the average amount of data transmitted it is known to implement systems or methods for arbitration of network or bus access, i.e. pertaining to the order in which requests are serviced.

U.S. Pat. No. 5,901,294 discloses a bus arbitration method and system for a multiprocessor system having a plurality of processors and a common wide bus subdivided into a specified number of sub-buses, whereby the arbitration method and system basically grant simultaneous access to a selected number of the sub-buses to a particular one of the plurality of processors in response to a bus request issued by the particular one of the plurality of processors. Hence, this system discloses a bus arbitration logic connected to every single one of the processors and the common wide bus in order to control the bus and grant bus access to the connected processors. The whole idea is directed to the concept of addressing the variable data access requirements of multiple processors in a multiprocessor system.

### SUMMARY OF THE INVENTION

It is therefore an object of the present invention to provide an improved method and device for communication control in a data network or data bus, which can also be used with a wide range of standard communication facilities.

The foregoing object is achieved as is now described. A method and a device are provided for controlling the communication through a data network or bus. The data network or bus includes a data source and a transmission facility subdivided into a plurality of different channels. A subset of the plurality of channels is determined which the data source is allowed to seize. A data stream originating from the data source is transformed into a format permitting concurrent transmission over the subset of channels. Finally, the transformed data is transmitted concurrently over the subset of channels.

In preferred embodiments of the communication control method and device the transforming of the data stream is done in a way to use the maximum transmission rate provided by each channel of the transmission facility. Further, the method and the device are formed to allow redistribution of the transformed data stream among a reduced or an extended number of channels, depending whether utilized channels become unavailable or additional channels become available.

With the principles taught by the present invention a communication control method and device is provided which will allow one to utilize the provided bandwidth of a bus or network very efficiently. This will lead to a higher statistical availability of data transport capacity at a given time and this will allow one to use a lower performance depending on the targeted application respectively. Accordingly, the above features leading to a lower cost bus and/or network medium. Preferably the present invention can be applied to communication control systems used in automotive vehicles.

### BRIEF DESCRIPTION OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a high-level block diagram illustrating a part of a network to be used with the communication control method or device according to the present invention;

FIG. 2 is a diagram showing an exemplary course of channel seizure over time in accordance with the present invention;

FIG. 3 is a high-level block diagram showing an implementation of the communication control device in accordance with the present invention;

FIG. 4 is a high-level block diagram illustrating a communication control device in accordance with the present invention;

FIG. 5 is a high-level logic flowchart illustrating a control sequence for communication with a CPU interface;

FIG. 6 is a high-level logic flowchart illustrating a control sequence for data transmission;

FIG. 7 is a high-level logic flowchart illustrating a control sequence for bus utilization;

FIG. 8 is a high-level logic flowchart illustrating a control sequence for displacing an active transmission.

### DETAILED DESCRIPTION OF THE INVENTION

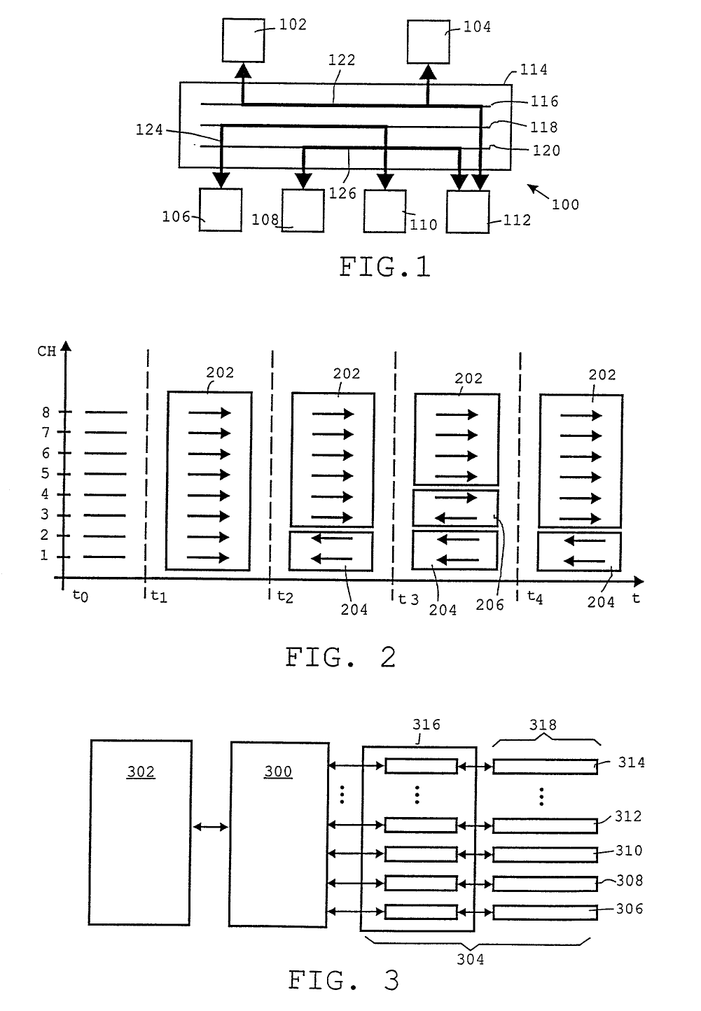

With reference now to the figures and, in particular, with reference to FIG. 1, there is depicted a high-level block diagram illustrating a part of a network 100 at a certain instant of time. The network 100 includes communication units 102 to 112 and a transmission facility 114.

The communication units 102 to 112 are either capable of accepting data signal from the transmission facility 114 or capable of originating data signals for the transmission facility 114, or both. Hence, each of the communication units 102 to 112 can act as a data sink, a data source or both.

The transmission facility 114 is subdivided into a plurality of channels 116 to 120. The number of channels is not restricted to three it rather can be any number. This allows one to establish multiple communication paths 122 to 126 at the same instant of time (indicated by thick lines). Furthermore, each communication path 122 to 126 can generally use more than one channel for transmitting data.

The communication paths 122 to 126 connect pairs or groups of communication units 102 to 112 together. The communication path 122 links communication units 102, 104 and 112, the communication path 124 links communication units 106 and 110 and the communication path 126 links communication units 108 and 112. Of course, communication unit 106 acts as a data sink for data being sent by communication unit 110, which in return acts as a data source and vice versa. It is acknowledged that in the following a data source is nothing else than a communication unit entering data into the network in that particular situation and a data sink is a communication unit accepting data from the network in a particular situation.

As shown in FIG. 1, the communication control method and device in accordance with the present invention are able to handle multiple connections through the transmission facility at the same instant of time.

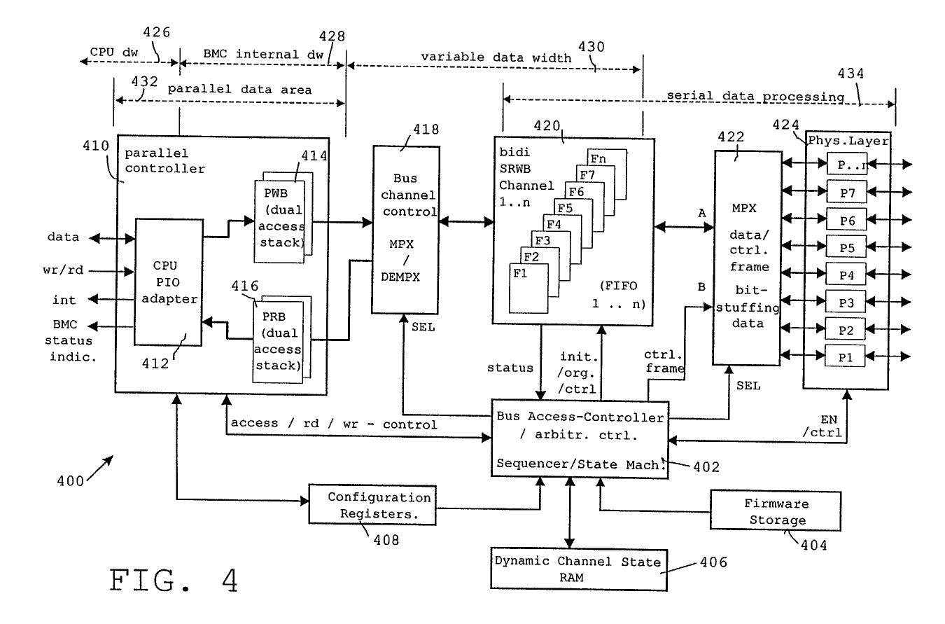

With reference to FIG. 2, there is depicted a diagram showing an exemplary course of channel seizure over time in accordance with the present invention. The diagram shows five snapshots of the utilization of the plurality of channels at five different instances of time t0 to t4 indicated on the x-axis. On the y-axis the transmission facility is shown, here subdivided into eight 1-bit channels CH1 to CH8.

The rectangular outlines group the channels belonging to one communication path.

The arrows inside the rectangular outlines give an idea how the particular channel is being used. An arrow pointing to one side symbolizes that this channel is used as a unidirectional serial connection. More than one arrow pointing in the same direction within the same rectangular outline indicate a unidirectional, parallel connection. Two or more arrows within the same rectangular outline pointing in opposite directions stand for a full duplex connection. It is understood that other combinations can be implemented as well.

The dotted lines between the rectangular outlines indicate a change in the seizure of the channels CH1 to CH8.

In order to establish a connection between two or more communication units 102 to 112 a subset of the plurality of channels CH1 to CH8 is determined. It is understood that a subset of channels also includes the case that all channels belong to a determined subset, as shown for the instant of time t1. Later on, the subset of channels is used for transmitting data between the particular communication units.

The process of determining the subset of channels is initiated by the communication unit acting as a data source, i.e. the one sending the data. In this process only such channels get selected which the initiating communication unit is allowed to seize, i.e. to gain control of In general, this is dependent on the condition of each channel of the plurality of channels. The condition of a channel is mainly made up by the fact whether the channels is occupied or free in that particular situation. Furthermore, the condition is made up by the priority of information transmitted over a busy channel.

On the other hand, determining a subset of channels is affected by characteristics of the communication unit requesting to send data and characteristics of each one of the plurality of channels to be used for transmitting the data. This includes, in particular, a maximum number of channels to seize specified for each communication unit, the communication unit's priority of sending data over the transmission facility and the maximum bit rate the communication unit can enter into the network.

For the transmission facility the following characteristics are relevant, in particular, the overall number of channels and the maximum transmission rate of each channel.

It is acknowledged that not all of the aforementioned characteristics need to affect the determining of the subset of channels. Some of the characteristics are rather governed by others. For example, the maximum number of channels to seize can be dependent on the maximum bit rate the communication unit can enter into the network. If the bit rate is extremely low too many data might need to get buffered in order to utilize more than one or two channels at its maximum transmission rate.

The communication unit's and the transmission facility's characteristics are advantageously stored in a table, in order to speed up the processing of determining the subset of channels. Hence, in the determining step a table lookup provides all information about the communication unit and the transmission facility. However, the conditions of the channels still need to be monitored, but this is done anyhow in order to detect which of the data transmitted through the transmission facility is dedicated to a particular communication unit acting as a data sink.

The present invention should not be understood that in every case all of that information needs to be stored in memory or some table. A part of that information might not be needed in some embodiments or might be calculated during runtime.

Focusing on instant of time t0 in FIG. 2, all channels are free. Now, it is assumed that communication unit 106 needs to send data to communication unit 110 as depicted in FIG. 1. Thus, communication unit 106 is acting as a data source and communication unit 1 10 is acting as a data sink in this scenario. The communication unit 106 initiates in the following a first connection 202.

Further assuming that communication unit's maximum number of channels to seize is eight and its maximum bit rate is high enough to enter so much data into the transmission facility that all channels are utilized with its maximum transmission rate.

However, another aspect of the present invention is to transform a data stream originated by a communication unit always in a way that the occupied channels are utilized with its maximum transmission rate. If there is a difference between the data rate of the data stream and the transmission rates of the channels taken for transmitting the data stream, then a routine or a storage is used to compensate for that difference, i.e. the data is buffered.

If the bit rate of the data stream is even lower than the transmission rate of one single channel, then the data stream gets buffered and the transmission only gets started when enough data is stored. In this case, of course, it has to be taken into consideration that the delay caused by the buffering does not exceed a time critical for the respective application.

On the other hand, if the bit rate of the data stream is higher than the sum of the transmission rates of the occupied channels, a lower bit rate is requested from the data source or the data is buffered.

Continuing the determining process, since all channels are available, the first connection 202 is allowed to seize all channels. In the following the data stream to be transmitted is transformed into a format permitting concurrent transmission over the subset of channels. As aforementioned the transforming is performed in such a way to enable utilizing the maximum transmission rate characteristic for each of the channels.

After taking control over the determined channels, the transformed data stream gets transmitted concurrently over the subset of channels.

In one embodiment of the present invention transforming the data stream includes creating data packets containing the information of the data stream. The advantage of a packet transmission is the ease of spreading the packets over any different number of channels available for transmission.

In accordance to the present invention, the transmission itself can be performed using known network protocols.

On instant of time t1 in FIG. 2 the result of the above seizure is shown. All channels CH1 to CH2 are occupied by connection 202. As the arrows inside the rectangular outline indicate connection 202 is an 8-bit PIO (parallel input/output) unidirectional data connection. While the transmission of data over connection 202 continues, a second connection 204 needs to get established.

The ongoing monitoring of the channels detects that all channels are busy. It is assumed that the priority of the information currently transmitted over the channels is lower than the priority assigned to the communication unit attempting to send over the second connection 204. More particular, the comparison of the priority leads to the result that for the second connection 204 two of the channels currently taken by the first connection 202 has to be freed.

This means that the data stream to be transmitted over the second connection 204 gets transformed into a format permitting concurrent transmission over two channels CH1 and CH2. The transmission of the data starts after taking over control of the two channels CH1 and CH2. For the point of view of establishing the second connection the same steps are performed as for the initial constituting of the first connection 202.

Since the two channels CH1 and CH2 taken over by the second connection 204 are not available anymore for the first connection 202, an additional step is performed in order to ensure the correct data transmission over the first connection 202. The transformed data stream is redistributed among a reduced subset of channels CH3 to CH8, since the channels CH1 and CH2 became unavailable during transmission.

Instant of time t2 in FIG. 2 shows the result of the transmission facility's reorganization or rather the new seizure of channels. The first connection 202 now utilizes the channels CH3 to CH8 while the second connection 204 utilizes the channels CH1 and CH2. As indicated by the arrows, the first connection 202 has now changed to a 6-bit PIO unidirectional connection and the second connection 204 was established as a 2-bit PIO unidirectional connection.

Going to instant of time t3 in FIG. 3, a third connection 206 has been established, again taking control over two channels CH3 and CH4 formerly utilized by the first connection 202. In this case, as indicated by the arrows, the third connection is a serial full-duplex connection transmitting data concurrently in both directions. Again, the data stream formerly transmitted over the 6-bit PIO connection of connection 202 was redistributed to enable a transmission over a 4-bit PIO connection as established in the instant of time t3 covering the channels CH5 to CH8.

A new scenario occurs when a connection is not needed anymore and channels get freed. Assuming the data transmission over the third connection 206 is completed and the channels CH3 and CH4 are available again. Immediately, again depending on the communication unit's or the channel's characteristics one of the existing connections take control over the freed channels CH3 and CH4. In the example shown in FIG. 2 the freed channels CH3 and CH4 are taken by the first connection 202. In order to utilize all available channels efficiently a redistribution is performed again. The data stream formerly transmitted over four channels CH5 to CH8 is redistributed among an extended subset of channels CH3 to CH8, since two additional channels CH3 and CH4 became available.

The result of that reorganization is shown in FIG. 2 at the instant of time t4, which is equivalent to the one at t2.

Although the present invention is explained to be used generally with a network it can preferably use for a network segment or a data bus as well. A network segment refers to a part of a network on which all message traffic is common to all communication units. That means that it is broadcast from one communication unit on the segment and received by all others. In general, this also applies to a data bus.

Since all communication units share the same physical medium forming the transmission facility in a network segment or a bus, collision detection or some other protocol is utilized to determine whether a message was transmitted without interference from other communication units. If a collision is detected then the data must be resent. The resending algorithm should try to minimize the chance that two node's data will repeatedly collide.

For example, the CSMA/CD (Carrier Sense Multiple Access/Collision Detect) protocol used on Ether net can be used with the present invention. Furthermore, token ring, a computer local area network arbitration scheme in which conflicts in the transmission of messages are avoided or token bus, a networking protocol that mediates access to a bus topology network as though it were a token ring can be used for the actual transmission of data. It is understood that the communication control method and device can advantageously be used with a wide range of known network protocols.

However, it is understood that the procedure in accordance with the present invention described above also applies for any number of channels and connections on networks, network segments and buses as well.

One major advantage of the present invention is that the maximum bandwidth or transmission rate of every single channel is utilized as long as there are some data to be transmitted. Of course, if no data need to be transmitted the transmission facility is not used at all. Hence, if there is data to be transmitted the bandwidth of the overall transmission facility is fully utilized, regardless if lower transport capacity is required by the respective data stream to be transmitted. In comparison to standard bus or network management techniques, the principle taught by the present invention will allow one to utilize the provided bandwidth of a bus or network very efficiently. This key attribute will lead to a higher statistical availability of data transport capacity at a given time and depending on the targeted application it will allow one to use a lower performance respectively. Thus, this feature leads to a lower cost bus and network medium respectively.

Another advantage is that the present invention is not restricted to certain protocols or message frame formats. A method or device according to the present invention can be implemented supporting all major data transport protocols and data transfer adjectives. Furthermore, the principle is supporting all bus systems and networks featuring multiple transport channels. It can be implemented for base band buses or networks, as well as in multiple modulated networks. All connection types, operating types, transmission variants, transmission control types can be supported by the presented principles.

FIG. 3 shows a high-level block diagram depicting an implementation of a communication control device 300 in accordance with the present invention. The communication control device 300 is arranged between a communication unit 302 and a transmission facility 304 that is subdivided into a plurality of channels 306 to 314. The communication unit 302 can be any I/O unit, data source or data sink, for example, an I/O port of a processor or controller, the output of an ADC (analog digital converter) or a DSP (digital signal processor). The transmission facility 304 can be any kind of network, bus system or communication line that can be subdivided into multiple channels, thus, for example, any communication lines suitable for any kind of multiplexing.

The transmission facility 304 is again split into a physical layer 316 and a bus medium 318 providing the plurality of channels 306 to 314. The plurality of channels 306 to 314 do not need to be implemented as separate physical lines, but can be formed, for example, by a single physical line that is able to support multiple channels. The physical layer 316 converts the respective data output of the communication control device 300 into the signal form suitable for the bus medium 318 used together with the communication control device 300.

With reference to FIG. 4, there is depicted a high-level block diagram illustrating a communication control device 400 in accordance with the present invention. As depicted, the communication control device 400 includes a bus access controller 402. The bus access controller 402 also functions as an arbitration controller controlling the order in which requests are serviced. For example, first-come/first-served or shortest-job-next or any priority-driven scheme. Therefore, the bus access controller 402 comprises a sequencer and a state machine for controlling the arbitration process. The bus access controller 402 is interconnected to all other functional parts of the communication control device 400.

First of all, it is interconnected to a firmware storage 404. Firmware refers to software stored in read-only memory (ROM) or programmable ROM (PROM). The firmware stored in the firmware storage 404 is responsible for the behavior of the bus access controller 402 when it is first switched on and for its later operation. In order to be able to store information during runtime the bus access controller 402 is interconnected to a dynamic channel state RAM 406 (random access memory).

Another interconnection is established to configuration register 408 (CR) which itself is connected to a parallel controller 410. However, there can be more than one register within the configuration register 408. The configuration register 408 is designed with identical bit-assignment layout for all communication control devices 400 participating within a communication control device accessed network. The configuration register 408 contains all key specification data for a network node formed by the respective communication control device 400.

Preferably, the communication register 408 bit-assignment layout is defined at the time of the overall system and network design phase. An example outlining the communication register content (‘Address Map’) is provided in the following. It is acknowledged that specific system designs may require only a subset or additional statements, i.e., control data:

CR Address Map

(1) Bandwidth allocation statement

(a) unrestricted channel allocation for 1 to n channels

(b) preferred number of channels

(c) minimum number of channels required

(d) special channel utilization: single channel or n channel allocation, define ‘bit-location’ (e.g. every 5th bit)

(2) Specific communication control device node allocation priority definition

(a) no priority statement

(b) priority level—n stages—low to high priority

(3) Message transfer latency time limits

(a) unrestricted

(b) definition of max. latency time t1 (sec)

(4) Bus arbitration delay

(a) no delay, immediate arbitration

(b) arbitration delay in: seconds, number of clock-cycles, or number of message bits written to PWB (parallel write buffer)

(5) Minimum number of bytes loaded to PWB prior to enable message transmission

(6) Frame control (FC) data length code: number of bits for frame control field FC (1) and FC (2) (unless defined in FC)

(7) Emergency bus allocation

(a) immediate transfer or specific delay

(b) ignore (no wait) acknowledge answer statement and initiate immediate transmission

In order to control and manage the bus media allocation procedure and the bus access procedure, a frame control field (FC) is defined. The frame control field (FC) is a data field that is specifically defined for the communication control device 400 and gets preferably appended to the actual message frame to be transmitted as a header. The FC data field provides on hand information required to initiate the bus access and message transmission and, on the other hand, it provides the acknowledging information for indicating a successful message transmission and reorganization data releasing the prior allocated bus media channels (and/or time slices).

Similar to the design of the configuration registers, the frame control field bit-assignment is advantageously defined at the time of the overall system and network design phase. An example describing demanded frame control field bit-assignment is provided in the following. However, it is understood that specific system designs may require only a subset or additional statements or data fields:

FC field Address Map (Appended Message Frame Header)

(1) FC field message frame header identifier

(2) Bus/Channel allocation status (demand) broadcast

(a) updated on allocation demand

(b) updated on ‘message transmission successful completed’ (release channels)

(3) Active message transmission status, displaying the number of bits successfully received by all (concurrent) message transfer tasks in execution prior to the bus-reorganization/channel displacement.

(4) FC data length code: number of bits for FC (1) and FC (2) (unless defined in CR)

The following optional data, to be determined by system design, could be part of the ‘embedded’ message itself:

(5) Destination address

(6) Source address

(7) number of bytes/frames to be transmitted

(8) CRC (cyclic redundancy check) code

(9) control bits

(10) . . . etc. . . .

Again focusing on FIG. 4, not only the configuration register 408 but also the bus access controller 402 is interconnected to the parallel controller 410. Over this interconnection line access, read and write control signals are transmitted. The parallel controller 410 comprises a CPU (central processing unit) PIO (parallel input/output) adapter 412, a parallel write buffer 414 (PWB) and a parallel read buffer (PRB) 416.

The CPU PIO adapter provides several data lines to be connected to a communication unit (not shown), whereby the communication unit could be formed by any I/O unit, data source or data sink, for example, an I/O port of a processor, CPU or controller, the output of an ADC (analog digital converter) or a DSP (digital signal processor). The provided data lines are capable to transmit data signals, read/write signals, interrupt signals and status indicator signals.

Both, the parallel write buffer 414 and the parallel read buffer 416 are connected to a bus channel control 418. In the implementation depicted in FIG. 4 the bus channel control 418 is realized as a multiplexer (MPX) and demultiplexer (DEMPX), that is, a functional unit that permits two or more data sources to share a common transmission medium such that each data source has its own independent channel. The PWB 414 writes data coming from the CPU PIO adapter 412 to the bus channel control 418, whereas the PRB 416 reads data appearing from the bus channel control 418 and transmits them to the CPU PIO adapter 412. The bus channel control 418, however, is again controlled by the bus access controller 402 over a respective data line.

From the bus channel control 418 the data enter a bi-directional serial read/write buffer (SRWB) 420 comprising n first-in-first-out (FIFO) data queues F1 to Fn, whereby n is an integer number greater than one. The SRWB 420 forwards the data to a multiplexing unit 422, where the data finally reach the physical layer 424 comprising n data channels P1 to Pn, whereby n is again an integer number greater one. The SRWB 420, the multiplexing unit 422 and the physical layer 424 are all controlled by the bus access controller 402. In return, the SRWB 420 provides the bus access controller 402 with status information.

Additionally, FIG. 4 shows where the data width changes within the communication control device 400. Beginning with the CPU data width 426 on the left hand side of the block diagram where the communication with a CPU or a respective device (not shown) takes place. Within the parallel controller 410 the data width is fix to an internal data width 428 provided by the communication control device 400. The internal data width 428 changes between the parallel controller 410 and the bus channel control 418 into a variable data width 430.

Furthermore, it is depicted where parallel and where serial data processing takes place. Whereas the parallel controller 410 computes the data received from the CPU (not shown) in parallel 432, from the SRWB 420 onwards the data is processed serially 434.

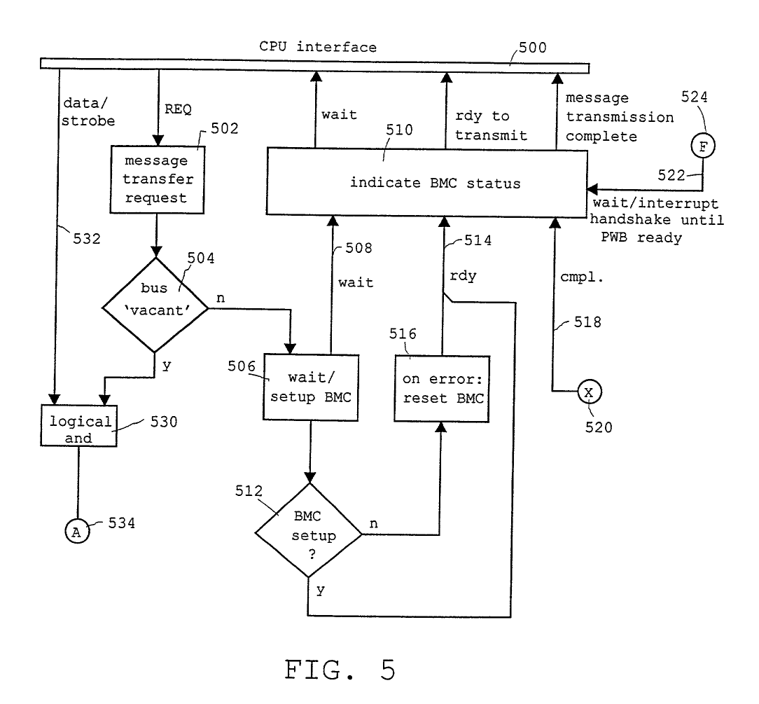

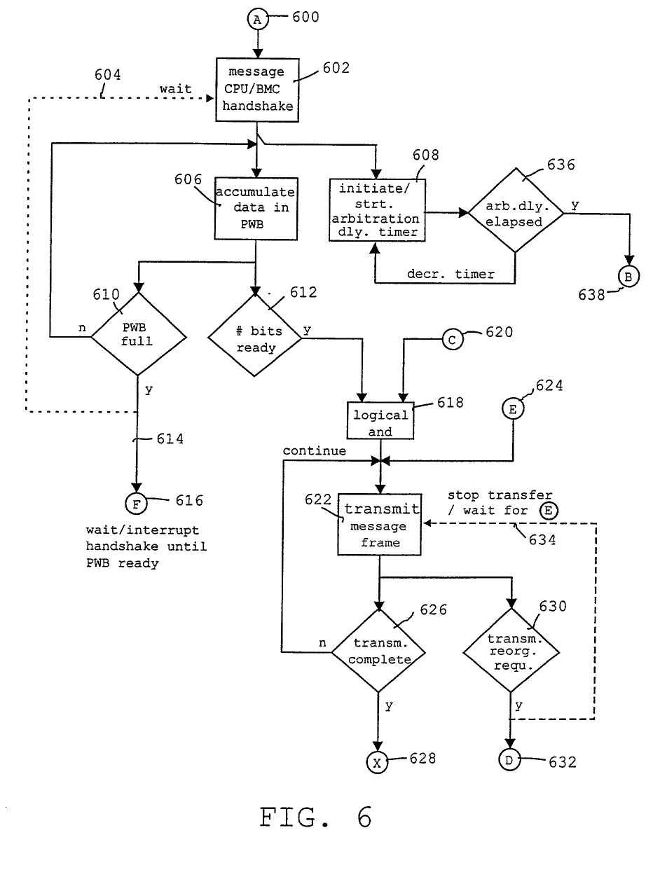

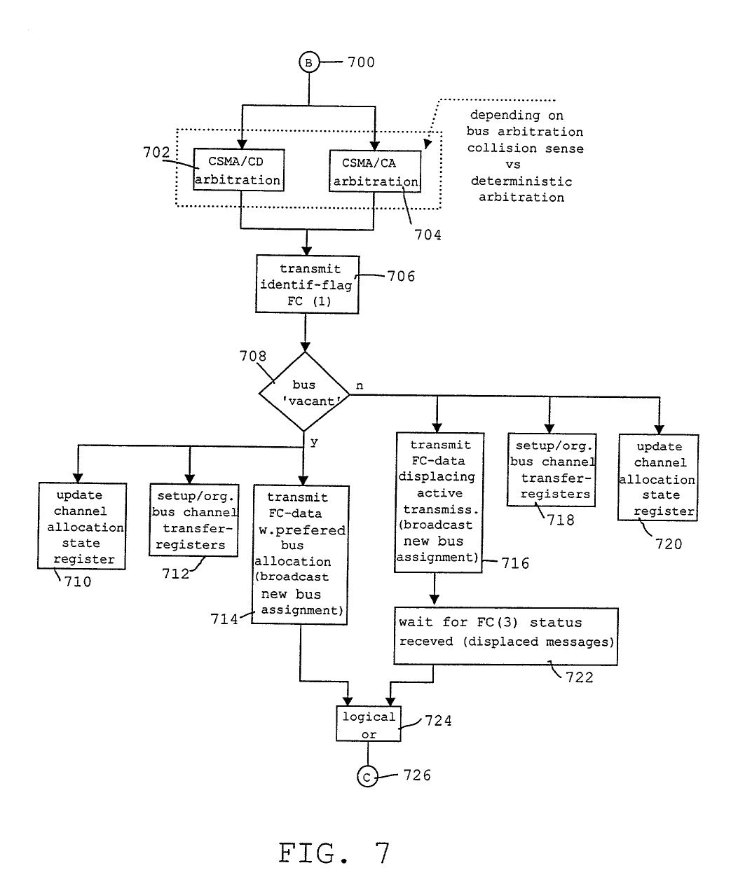

Next, with reference to FIG. 5, there is depicted a high-level logic flowchart illustrating a control sequence for communication with a CPU interface connected to the communication control device (BMC) according to the present invention. However, in FIG. 5 and the following FIG. 6 to 8 only the write access is depicted, that is, data is transmitted from a communication unit through a communication control device (BMC) according to the present invention into a transmission facility. The process of a read access operates in the opposite way, respectively. It is to be noted that for the sake of clarity the whole process is spread over FIG. 5 to 8, whereby capital letters A to F and X indicate connections between the single flowcharts.

The process is initiated by a CPU interface 500 by sending a message transfer request illustrated by block 502 and thereafter the process passes to block 504. Block 504 depicts a determination of whether or not any data buses are vacant, i.e., available to be seized by the requesting message transfer process.

If not, the process passes to block 506. Block 506 depicts a branching of the flow of action. On the one hand, a wait signal 508 is passed to block 510 indicating the status of the communication control device (BMC) to the CPU interface 500. On the other hand, the process passes to block 512. Block 512 illustrates a determination of whether or not the communication control device (BMC) has already been set up, i.e., whether or not it is in a state of normal operation, and if so, the process passes to block 510 indicating the status as to be ready by the respective signal 514.

Still referring to block 512, in the event the communication control device (BMC) not having been set up correctly or being in an erroneous state the process passes to block 516. Block 516 illustrates the resetting of the communication control device (BMC). After successfully resetting the communication control device (BMC) the ready signal 514 is sent to block 510 indicating the status of the communication control device (BMC).

Now, still focusing on block 510, block 510 has got two more entry points for the process flow or signals. Firstly, the completion signal entering at a connection point X in block 520 that has its origin in FIG. 6. Secondly, a signal 522 entering at a connection point F in block 524 (cf. FIG. 6). The signal 522 is indicating the communication control device (BMC) to wait until the parallel write buffer (PWB) is ready. This can be realized by waiting for the ready signal in a polling fashion or via an interrupt-driven method. However, a handshake procedure is implemented to ensure that the process does not continue before the parallel write buffer (PWB) is actually ready.

From block 510 different messages are passed to the CPU interface 500 depending on the status of the communication control device (BMC).

Returning to block 504, in the event there is at least one bus available the process passes to block 530. Block 530 depicts a logical ‘and’ between a positive result of the determination of block 504 and the occurrence of a data strobe signal 532 coming from the CPU interface 500. Hence, only when both such prerequisites are fulfilled the process passes to the connector A in block 534 leading to connector A in block 600 shown in FIG. 6.

Referring now to FIG. 6, there is depicted another portion of a high-level logic flowchart illustrating a control sequence for communication with a CPU interface connected to the communication control device (BMC) according to the present invention and, in particular, a high-level logic flowchart illustrating a control sequence for data transmission.

Beginning with entry point A in block 600, if the process has passed block 530 shown in FIG. 5 it reaches block 602 shown in FIG. 6. Block 602 illustrates a message CPU/communication control device (BMC) handshake procedure ensuring that the data to be sent from the CPU to the communication control device (BMC) are transmitted correctly. In other words, there is a protocol defined for the communication between the CPU interface and the communication control device (BMC) that comes into place during the transmission of data from the CPU interface (cf reference number 500 in FIG. 5). The dotted line indicates a wait signal 604. The wait signal 604 is meant to illustrate that the protocol or handshake procedure between the CPU interface and the communication control device continues the whole time of information transmission.

After block 602 the process branches again reaching now blocks 606 and 608, concurrently. Block 606 depicts the accumulation of data sent by the CPU interface 500 (FIG. 5) in the parallel write buffer, whereas block 608 illustrates the initialization and the start of an arbitration delay timer (not shown) included in the communication control device in accordance with the present invention.

After block 606 the process reaches blocks 610 and 612 concurrently. Block 610 illustrates a determination of whether or not the parallel write buffer is full, i.e., all buffer memory is taken. If yes, the process waits until the parallel write buffer (PWB) is ready again. This is indicated by the wait signal 604 passed back to block 602 along the dotted line and by a signal 614 (reference number 522 in FIG. 5) that is transmitted to block 510 of FIG. 5 as indicated by the connector F in block 616. If there is still space left in the parallel write buffer the process then returns from block 610 to block 606 in an iterative fashion to continue accumulating data in the parallel write buffer (PWB) as described above.

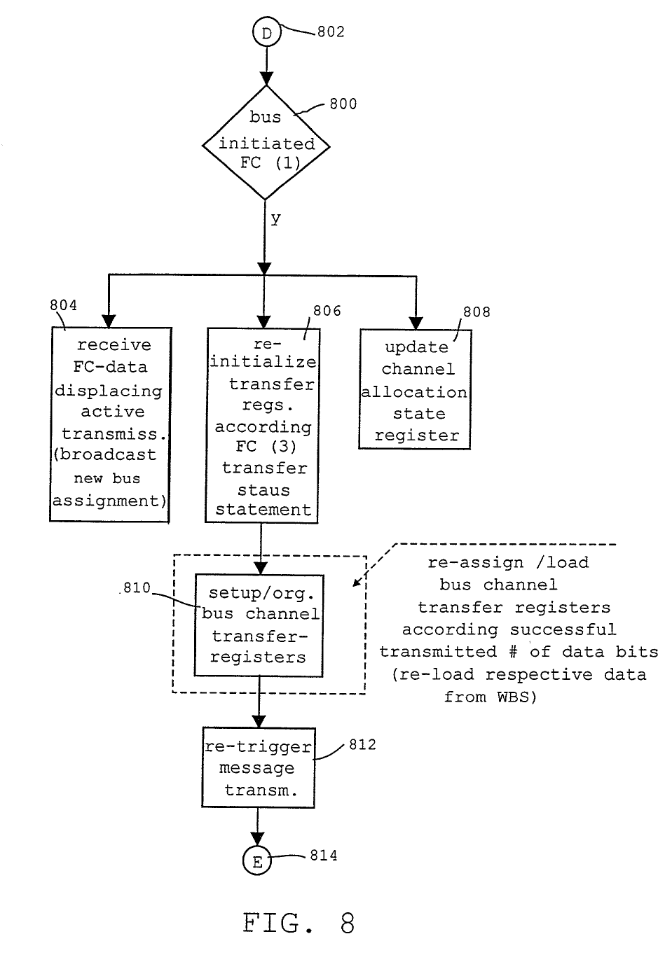

Referring again to block 612, the process only proceeds from here to block 618, if the bit count of data accumulated in the parallel write buffer (PWB) has reached a specified amount. Block 618 depicts a logical ‘and’ between a positive result of the comparison of block 612 and the appearance of the process coming from the connector C in block 620 (cf. FIG. 7). In other words, only when both such prerequisites are fulflled the process passes to block 622. The process also reaches block 622 through connector E in block 624 (cf. FIG. 8).

Still referring to block 622, block 622 depicts the transmission of a message frame. The transmission is continued until the transmission of the message frame is completed. As illustrated in block 626 depicting a determination of whether or not the whole message frame has been sent the process returns to block 622 in an iterative fashion, if the transmission is still going on. If the transmission is completed the process passes to connector X in block 628 sending a completion signal to the communication control device status block 510 in FIG. 5.

Concurrently to the transmission of a message frame the communication control device is monitoring whether or not a transmission reorganization request occurs, as illustrated in block 630. Only if such a request occurs the process continues to connector D in block 632 leading to block 800 via block 802 both shown in FIG. 8. At the same time, the transmission of the message frame is stopped until all bus channels are reassigned. This is indicated by the dotted line returning a stop transfer signal 634 back to block 622. In other words the frame transmission process waits for connector E, that is, the transmission is interrupted until the process initiated by the transmission reorganization request returns to block 622.

Coming back to block 608 illustrating the initialization and the start of an arbitration delay timer (not shown), from block 608 the process continues to block 636. Block 636 illustrates a determination of whether or not the arbitration delay time is elapsed. If yes, the process proceeds to connector B in block 638 leading to connector B in block 700 shown in FIG. 7. If the arbitration time has not elapsed, i.e., the timer has not reached zero, the timer is decreased or counted down and the process is returned to block 608 in an iterative fashion.

Referring now to FIG. 7, showing a continuation of a high-level flowchart illustrating a control sequence for communication with a CPU interface connected to the communication control device (BMC) according to the present invention, and in particular, showing a high-level logic flowchart illustrating a control sequence for bus utilization. Starting off from the connector B in block 700 the process reaches either block 702 or block 704 depending on the network arbitration protocol being used. If the Carrier Sense Multiple Access/Collision Detect (CSMA/CD) protocol is used the process passes to block 702, otherwise, if a deterministic arbitration protocol, such as Carrier Sense Multiple Access/Collision Avoidance (CSMA/CA), is used the process will reach block 704.

After a successful arbitration and getting access to the bus, the process flow reaches block 706 coming either from block 702 or from block 704 depending on the arbitration protocol used as explained above. Block 706 depicts the transmission of frame control field FC (1), explained above in greater detail. Frame control field FC (1) includes the message frame header identifier. Next, the process passes to block 708 depicting a determination of whether or not a bus is vacant. If yes, three tasks indicated by blocks 710, 712 and 714 are done concurrently. Whereby block 710 depicts updating of the channel allocation register, block 712 depicts the setup or organization of the bus channel transfer registers and block 714 depicts the transmission of frame control field data with a preferred bus allocation or the broadcasting of a new bus assignment, respectively.

On the other hand, if none of the buses are available for seizure the tasks depicted in blocks 716, 718 and 720 are performed. Whereby block 716 depicts the transmission of the frame control field (FC) data, the displacing of the active transmission and the broadcasting of a new bus assignment. Block 718 depicts the setup or organization of the bus channel transfer registers and block 720 depicts the updating of the channel allocation register. Thereafter, the process passes from block 716 to block 722. Block 722 illustrates the process waiting for the reception of the frame control field FC (3) status, i.e., active message transmission status, displaying number of bits successfully received by all concurrent message transfer tasks in execution prior to the bus-reorganization or channel displacement.

In the following, the flow of operation from block 714 and 722 join to meet at block 724 depicting a logical ‘or’, i.e., the process will continue either it came from block 714 or from block 722. Then the process will return in an iterative fashion via connector C in block 724 and via connector C in block 620 to block 618 (both shown in FIG. 6).

Finally, with reference to FIG. 8, there is depicted another portion of the high-level flowchart illustrating a control sequence for communication with a CPU interface, and in particular, there is depicted a high-level logic flowchart illustrating a control sequence for displacing an active transmission. The process only proceeds from block 800, if the bus is being initiated according to the frame control field FC (1), i.e., the frame control field message header identifier.

Thereafter, three tasks are performed concurrently, illustrated by blocks 804, 806 and 808. Block 804 depicts the reception of frame control field data FC, the displacing of active transmission and the broadcasting of a new bus assignment. Block 806 illustrates the re-initialization of the transfer registers according to frame control field FC (3), as explained above. Furthermore, block 808 symbolizes the update of the channel allocation state registers.

After concluding such tasks the process passes from block 806 to block 810 depicting the setup and organization of the bus channel transfer registers respectively. This includes the reassignment or load of the bus channel transfer registers according to the successful transmitted number of data bits and the reload of the respective data.

Next, the process passes to block 812 that illustrates the re-triggering of the message transmission which gets forwarded via connector E in block 814 and block 624 to block 622, both shown in FIG. 6.

The present invention can be realized in hardware, software, or a combination of hardware and software. Any kind of computer system or other apparatus adapted for carrying out the methods described herein is suited. A typical combination of hardware and software could be a general purpose computer system with a computer program that, when loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

What is claimed is:

1. A communication control method for a network having a data source and a transmission facility subdivided into a plurality of channels, said method comprising the steps of:
determining a subset of said plurality of channels which said data source is allowed to seize;
transforming a data stream originating from said data source into a format permitting concurrent transmission over said subset of said channels; and
transmitting the transformed data stream concurrently over said subset of said channels.

2. The communication control method of claim 1, wherein said step of transforming said data stream is performed in such a way as to enable utilizing a maximum transmission rate characteristic for each of said channels.

3. The communication control method of claim 1, further including the step of redistributing said transformed data stream among a reduced subset of said channels if during transmission of said transformed data stream one or more channels of said subset of said channels become unavailable.

4. The communication control method of claim 1, further including the step of redistributing said transformed data stream among an extended subset of said channels if during transmission of said transformed data stream one or more additional channels become available.

5. The communication control method of claim 1, wherein said step of determining a subset of said plurality of channels includes the step of looking up data in a table containing information about said data source.

6. The communication control method of claim 5, wherein said information about said data source includes a maximum number of channels to seize.

7. The communication control method of claim 5, wherein said information about said data source includes a data source's priority of sending data over said transmission facility.

8. The communication control method of claim 5, wherein said information about said data source includes a maximum bit rate said data source can enter into said network.

9. The communication control method of claim 1, wherein said step of determining a subset of said plurality of channels includes the step of looking up data in a table containing information about said transmission facility.

10. The communication control method of claim 9, wherein said information about said transmission facility includes an overall number of channels.

11. The communication control method of claim 9, wherein said information about said transmission facility includes a maximum transmission rate of each channel.

12. The communication control method of claim 9, wherein said step of determining a subset of said plurality of channels includes the step of examining the condition of said plurality of channels.

13. The communication control method of claim 12, wherein said step of examining said condition of said plurality of channels includes the steps of finding free channels and checking the priority of information currently transmitted over busy channels.

14. The communication control method of claim 13, wherein said step of determining a subset of said plurality of channels includes the step of selecting one or more of said busy channels to take over control for transmitting data if said priority of information currently transmitted has got a lower priority.

15. The communication control method of claim 1, wherein said step of transforming said data stream includes the step of buffering said data stream.

16. The communication control method of claim 1, wherein said step of transforming said data stream includes the step of creating data packets containing said information of said data stream.

17. The communication control method of claim 1, wherein said step of transmitting said transformed data stream includes the step of utilizing standard network protocols.

18. A computer program product stored on a computer usable medium, comprising computer readable program means for causing a computer to perform the method of claim 1.

19. A communication control device for a network having a data source and a transmission facility subdivided into a plurality of channels, said device comprising:
a bus access controller for determining a subset of said plurality of channels which said data source is allowed to seize;
a bus channel control for transforming a data stream originating from said data source into a format permitting concurrent transmission over said subset of said channels; and
a multiplexing unit for transmitting the transformed data stream concurrently over said subset of said channels.

20. The communication control device of claim 19, further including a configuration register containing information about said data source.

21. The communication control device of claim 20, wherein said information about said data source includes a maximum number of channels to seize.

22. The communication control device of claim 20, wherein said information about said data source includes a data source's priority of sending data over said transmission facility.

23. The communication control device of claim 20, wherein said information about said data source includes a maximum bit rate the data source can enter into said network.

24. The communication control device of claim 20, wherein said configuration register further contains information about said transmission facility

25. The communication control device of claim 24, wherein said information about said transmission facility includes an overall number of channels.

26. The communication control device of claim 24, wherein said information about said transmission facility includes a maximum transmission rate of each channel.

27. The communication control device of claim 19, wherein said bus access controller for determining a subset of said plurality of channels includes an arbitration controller for scheduling transmission requests.

28. The communication control device of claim 19, further including buffers for transforming said data to be concurrently transmitted over a specified number of channels.
